(19) United States
(12) Patent Application Publication
(10) Pub. No.: US 2022/0289962 A1
(43) Pub. Date: Sep. 15, 2022

(54) ELECTRICALLY CONDUCTIVE NANOCOMPOSITE PARTICLES WITH A POLY ALKYLACRYLATE CORE AND A CONDUCTIVE POLYMER SHELL

(71) Applicants: UNIVERSITÉ DE PAU ET DES PAYS DE L'ADOUR, PAU (FR); CENTRE NATIONAL DE LA RECHERCHE SCIENTIFIQUE, Paris (FR)

(72) Inventors: Stéphanie REYNAUD, LONS (FR); Pierre MARCASUZAA, LESCAR (FR)

(73) Assignees: UNIVERSITÉ DE PAU ET DES PAYS DE L'ADOUR, PAU (FR); CENTRE NATIONAL DE LA RECHERCHE SCIENTIFIQUE, Paris (FR)

(21) Appl. No.: 17/638,584

(22) PCT Filed: Sep. 2, 2020
(86) PCT No.: PCT/EP2020/074462

§ 371 Date: Feb. 25, 2022

(30) Foreign Application Priority Data
Sep. 4, 2019 (FR) FR1909720

(51) Int. Cl. C08L 33/08; C08L 77/00; C08L 41/00; H01B 1/12

(52) U.S. Cl. CPC C08L 33/08; C08L 77/00; C08L 41/00; H01B 1/12; C08L 2203/20; C08L 2207/53; B82Y 40/00

(57) ABSTRACT

The present invention relates to electrically conductive nanocomposite particles comprising: a core consisting of a poly-C1-C6-alkyl-acrylate homopolymer or of a C1-C6 alkyl acrylate copolymer and an α,β-unsaturated amide comonomer, a shell comprising a conductive polymer and a nonionic surfactant. The invention also relates to a process for the preparation of such particles, as well as their use for producing a print on a stretchable support.

### FIELD OF INVENTION

The present invention relates to the technical field of stretchable conductive materials, in particular for the fields of printed electronics requiring elasticity.

The presence of electronics in our lives is constantly increasing, and this trend is expected to grow exponentially in the years to come, with the arrival of the Internet of Things (IoT, Internet of Things), and the next Internet of all objects (IoE, Internet of Everything).

The IoE can be set up thanks to the latest technological advancements, and mainly to the advancements acquired in the world of printed electronics. Printed electronics allow the production of flexible components and the production on large surfaces, in particular as a complement to traditional electronics on silica. The main differences in the devices obtained with traditional semiconductor technologies are in their thickness, weight, robustness and cost. These qualities have enabled the emergence of new markets and products, and have contributed to the development of innovative concepts such as portable electronics or smart labels. To be able to continue this development, there are still today technological barriers to be lifted with new technological approaches. In particular, there is today a growing interest in stretchable and flexible substrates, especially for “wearables”, such as connected clothing.

The industrially applied solutions in stretchable electronics today follow two approaches: on the one hand, circuit engineering with tracks drawn in the shape of waves and horseshoes, and on the other hand, nanocomposites of conductive nanoparticles, typically nanoparticles metal or carbon nanotubes, incorporated in an insulating elastomer matrix, and combinations of the two approaches. These two ways have significant performance limitations and the properties of the objects obtained by these ways are little or not kept under mechanical stress. The development of these materials is further limited by the complexity of manufacturing the devices. In the first approach, a non-stretchable inorganic material, typically a metal, is structured in a wave-like geometric pattern, which can be stretched if the elastomeric substrate is deformed. The feasibility has been demonstrated, but the manufacturing complexity and the space occupied by the circuits on the devices integrating said circuits represent significant constraints. In the second way, nanocomposites take advantage of the inclusion of conductive fillers in insulating elastomeric matrices. Materials such as carbon nanotubes, silver nanowires or metallic nanoparticles are used as conductive materials. Despite the versatility and large number of material choices, percolation-dependent conductivity is highly voltage-sensitive and remains an obstacle for miniaturization in the case of a device, and stability under cyclic deformation.

The developments carried out in recent years for applications in stretchable printed electronics, epidermal electronic type, allow intimate contact between stretchable conductive devices and curvilinear surfaces, with 100% deformation. These devices are based on the integration of rigid islands of active components with stretchable interconnections. But the development of conductive materials capable of maintaining conduction performance under deformation remains a key challenge.

In this context, intrinsically stretchable and conductive materials remain rare. Such materials would allow access to simple manufacturing processes, such as printing or coating processes. However, the production of such materials remains problematic. Indeed, several obstacles remain to be overcome, such as easy and inexpensive preparation and implementation, and/or the robustness of their properties under deformation.

An inherently stretchable and conductive material that can be solution deposited and can be patterned by printing is further desirable.

Conductive polymers are good candidates thanks to their flexibility and their electrical and mechanical properties. Unfortunately, to date, high conductivity and high stretchability could not be obtained simultaneously for conductive polymers. Sodium poly(3,4-ethylenedioxythiophene):poly(styrene sulfonate) (PEDOT:PSS) is a conductive polymer that can be deposited from solution and exhibits high conductivity, but exhibits strain fracture around by 5%.

Therefore, alternative solutions to the use of PEDOT:PSS alone have been developed, to improve the flexibility of the conductive polymers deposited while maintaining good conduction properties.

### BACKGROUND ART

The EP3221404 patent describes a conductive polymer coating comprising in particular a conductive polymer such as PEDOT and a polymer improving the flexibility of the coating, such as a copolymer of acrylamide and acrylic acid. This coating is indicated as particularly suitable for flexible surfaces and allows the conservation of the conductivity of the coating even after several stretching cycles. However, since the two polymers are simply mixed together, this coating may present risks of phase segregation and/or diffusion which are harmful to the conduction properties.

The WO2007012736 application describes electrically conductive particles comprising a poly n-butyl acrylate core, a polyaniline shell and a nonionic surfactant. These particles combine an elastomer core and a shell providing electrical conduction properties to the particles. Nevertheless, the WO2007012736 application does not describe the behavior of such particles when they are stretched, and in particular it does not describe whether electrical conduction is retained by the particles when they are stretched. Furthermore, although polyaniline is a conductive polymer, its conductivity is significantly lower than that of PEDOT:PSS. Finally, the particle synthesis process is specific to polyaniline.

### SUMMARY

The present invention relates to electrically conductive nanocomposite particles comprising:
a core consisting of a homopolymer of poly-C1-C6-alkyl-acrylate or of a copolymer of C1-C6 alkyl acrylate and an α,β-unsaturated amide comonomer;
a shell comprising a conductive polymer chosen from the group consisting of poly(3,4-ethylenedioxythiophene) (PEDOT), derivatives of PEDOT and poly(3-hexylthiophene) (P3HT); and
a nonionic surfactant.

The present invention also relates to a method for preparing a dispersion of particles comprising:
a core consisting of a homopolymer of poly-C1-C6-alkyl-acrylate or of a copolymer of C1-C6 alkyl acrylate and an α,β-unsaturated amide comonomer;
a shell comprising a conductive polymer chosen from the group consisting of poly(3,4-ethylenedioxythiophene) (PEDOT), derivatives of PEDOT and poly(3-hexylthiophene) (P3HT);
a nonionic surfactant,

said method comprising the steps of:

a) polymerization of C1-C6 alkyl acrylate monomers, and optionally α,β-unsaturated amide monomers, in the presence of a nonionic surfactant and a polymerization catalyst in a dispersing medium to obtain a latex in aqueous solution;

b) dissolving a polyelectrolyte stabilizing the conductive polymer in an aqueous solution to obtain an aqueous solution comprising said polyelectrolyte;

c) adding 3,4-ethylenedioxythiophene (EDOT) monomers, EDOT derivatives, or 3-hexylthiophene to the aqueous solution comprising the polyelectrolyte obtained in step (b);

d) adding a polymerization initiator and the latex obtained in step (a) to the solution comprising the polyelectrolyte and the monomers obtained in step (c); and

e) polymerization of the monomers to form the dispersion of particles.

The present invention also relates to the use of electrically conductive nanocomposite particles according to the invention for producing a print on a stretchable support.

The present invention finally relates to a printed stretch support, in which the print comprises at least one particle according to the invention.

Of course, the different characteristics, variants and embodiments of the invention can be associated with each other in various combinations insofar as they are not incompatible or exclusive of each other.

### BRIEF DESCRIPTION OF THE FIGURES

In addition, various other characteristics of the invention emerge from the appended description made with reference to the drawings which illustrate non-limiting forms of embodiment of the invention, wherein:

FIG. 1 is a graph showing the evolution of the resistance of the printed thermoplastic polyurethane specimen during the tensile test as a function of stretching.

FIG. 2 is a graph showing the evolution of the resistance (upper part) and stretching (lower part) of the printed thermoplastic polyurethane test piece during a tension/release cycle with a stretch of 120%.

FIG. 3 is a graph showing the evolution of the resistance (upper part) and stretching (lower part) of the printed thermoplastic polyurethane test piece during a tension/release cycle with a stretch of 150%.

FIG. 4 is a graph showing the evolution of the resistance of the printed Lycra test piece during the tensile test as a function of stretching.

FIG. 5 is a graph presenting the evolution of the resistance of the test piece of stretchable yarn printed during the tensile test as a function of time for a stretch of 110%.

FIG. 6 is a graph presenting the evolution of the resistance of the test piece of stretchable yarn printed during the tensile test as a function of time for a stretch of 125%.

FIG. 7 is a graph presenting the evolution of the resistance of the test piece of stretchable yarn printed during the tensile test as a function of time for a stretch of 150%.

### DETAILED DESCRIPTION

The present invention relates to electrically conductive nanocomposite particles comprising:
a core consisting of a homopolymer of poly-C1-C6-alkyl-acrylate or of a copolymer of C1-C6 alkyl acrylate and an α,β-unsaturated amide comonomer;
a shell comprising a conductive polymer chosen from the group consisting of poly(3,4-ethylenedioxythiophene) (PEDOT), derivatives of PEDOT and poly(3-hexylthiophene) (P3HT); and
a nonionic surfactant.

By “nanocomposites” is meant composite particles of size less than one micrometer. The size (diameter) of the core is generally in the range of 20 nm to 700 nm and the size of the shell (thickness) is generally in the range of a few nm to 100 nm. In one embodiment, the particle core diameter is less than 200 nm. Compared to larger particles, particles with a core diameter of less than 200 nm have advantages in terms of processing (deposition in the form of a film or easier impregnation), material savings (less conductive polymer needed to achieve percolation rates similar to those of the prior art) and conductivity. Without wishing to be bound by any theory, it would seem that the use of smaller conductive particles makes it possible to form a tighter network of conductive polymer within the film or the deposit by impregnation, which would promote conduction.

The size of the core and/or the shell of the particles can be measured by any suitable technique known in the art. It can in particular be measured by dynamic light scattering.

“Poly(3,4-ethylenedioxythiophene) (PEDOT)” means a polymer obtained by polymerization of EDOT (3,4-ethylenedioxythiophene) monomers. By derivative of PEDOT, is meant a polymer obtained by polymerization of monomers of derivatives of EDOT chosen from the group consisting of hydroxymethyl-EDOT, vinyl-EDOT, allyl ether of EDOT, EDOT-COOH, EDOT-MeOH; EDOT-silane, EDOT-acrylate, EDOT-sulfonate, EDOT-amine and EDOT-amide or a mixture of such monomers. By “poly(3-hexylthiophene) (P3HT)”, is meant a polymer obtained by polymerization of 3-hexylthiophene monomers. In a preferred embodiment, the conductive polymer is PEDOT or one of its derivatives, in particular it is PEDOT.

By “shell comprising a conductive polymer”, is meant a continuous or discontinuous deposit of conductive polymer physically bonded (i.e. adsorbed) and/or chemically (i.e. grafted) to the surface of the polyalkyl acrylate core. Preferably, this deposit is discontinuous. Preferably, the shell is adsorbed on the surface of the core. Advantageously, the conductive polymer, in particular PEDOT, can be mixed with at least one stabilizer and/or at least one dopant. In particular, the PEDOT can be present in the form of a mixture with a polyelectrolyte stabilizing it, such as poly(sodium styrene sulfonate) (PSS). This PEDOT:PSS mixture is well known to those skilled in the art, in particular because it is an intrinsically conductive polymer. Preferably, the molar ratio of EDOT:PSS repeating units in the PEDOT:PSS mixture is 1:1.

An “polyalkylacrylate homopolymer” means a polymer resulting from the linking of several identical alkyl acrylate monomer units.

Within the meaning of the present description, the term “polyalkyl acrylate” encompasses polyalkyl methacrylates. Examples of poly-C1-C6-alkyl-acrylates include polymethyl methacrylate, polymethyl acrylate, polyethyl acrylate, polyethyl methacrylate, poly-n-propyl or -isopropyl acrylate, poly-n-propyl or -isopropyl methacrylate, poly-n-, sec- or tert-butyl acrylate and poly-n-, sec- or tert-butyl methacrylate.

Preferably, the poly-C1-C6-alkyl-acrylate is poly-n-butyl acrylate. This advantageously has a glass transition temperature of −54° C., which makes it possible to obtain film-forming properties at ambient temperature.

According to a variant of the invention, the polyalkyl acrylate is crosslinked. Examples of particularly suitable crosslinking agents are in particular diacrylate compounds, preferably 1,6 hexanediol diacrylate. The latter is in particular available under the trade name SR238(R) (Cray Valley). The crosslinking of the polyalkyl acrylate in fact makes it possible to modulate the mechanical properties of the conductive composite and in particular to reduce its elasticity. A crosslinking agent differs from a comonomer in particular in that it has a functionality at least equal to two, when a comonomer generally has a functionality of 1.

According to another variant of the invention, the polyalkyl acrylate or the copolymer of C1-C6 alkyl acrylate and of an α,β-unsaturated amide comonomer which constitutes the core of the particles is not crosslinked, or at least not sufficiently cross-linked to harden the core of the particle. The absence of crosslinking makes it possible to maintain the mobility of the polymer chains and the percolation, while the two phases formed by the particles (core and shell) can appear in the form of two continuous phases one inside the other. The absence of crosslinking of the core contributes in particular to greater stretchability of the particles according to the invention.

According to a preferred variant of the invention, the core consists of a copolymer of C1-C6 alkyl acrylate and of an α,β-unsaturated amide comonomer.

Preferably, the weight ratio of polyalkyl acrylate/conductive polymer, in particular PEDOT, varies from 45/55 to 98/2 and is preferably between 50/50 and 95/5. In particular, the ratio by weight of polyalkyl acrylate/conductive polymer, in particular PEDOT, varies from 70/30 to 95/5, in particular it is equal to approximately 75/25, in particular it is equal to 75/25.

The particles according to the invention can be obtained by polymerization of PEDOT in a dispersion of polyalkyl acrylate stabilized by the presence of a surfactant. The surfactant can be nonionic or ionic, in particular cationic. It is preferably nonionic because ionic surfactants can interfere undesirably in polymerization reactions, in particular during the polymerization of PEDOT.

By “nonionic surfactant”, is meant a surfactant which is not charged under the operating conditions. The nonionic surfactant can be physically adsorbed to the surface of the polyalkyl acrylate particles (i.e. physically bound) or incorporated into the polyalkyl acrylate (i.e. chemically bound). Preferably, the nonionic surfactant is physically bound to the polyalkyl acrylate. This can be obtained by carrying out the polymerization of the polyalkyl acrylate in the presence of the nonionic surfactant.

The nonionic surfactant can be chosen from a wide variety of compounds including in particular alkylphenol alkoxylates, alcohol alkoxylates, alkyl alkoxylates, amine alkoxylates, alkylamine oxides, in particular from ethoxylates alkylphenol, alcohol ethoxylates, alkyl ethoxylates, or EO/PO (ethylene oxide/propylene oxide) block copolymers, amine ethoxylates or polyethoxylates.

The nonionic surfactant preferably has a hydrophilic/lipophilic balance (HLB) of between 12 and 20, in particular between 17 and 19, limits included. In particular, it may be the surfactant known under the name Brij™ S100, of formula I:

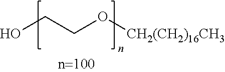

The amount of nonionic surfactant used is not critical and can vary to a large extent. Thus, dispersions of small particles generally require a higher amount of stabilizing surfactant than dispersions of larger particles. However, this quantity must be sufficient to make it possible to stabilize the polyalkyl acrylate particles and must not be too high so as not to alter the mechanical and conductive properties of the particles. The nonionic surfactant present in the particles according to the invention generally represents 1% to 20% by mass, and more preferably from 1 to 10% by mass, the values by mass being expressed relative to the total dry mass of the shell and of the core.

According to a particularly preferred variant of the invention, the particles also comprise a second nonionic surfactant possessing chemical functions capable of improving the conductivity of the composite. By way of examples, mention may be made of nonionic surfactants comprising at least one amide function, such as the compounds of formula II:

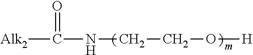

In formula II, AIk₂ denotes a C1-C20, preferably C1-C15, alkyl group, and m represents an integer from 1 to 100. According to a preferred variant, a compound corresponding to formula II is used, in which AIk₂ is a C11 alkyl group and m represents an average number of 6. This is commercially available under the name Ninol® (Stepan). Thus, without wanting to be limited to a theory, it has been demonstrated that the amide functions present on the surface of the core make it possible to obtain a better covering of the core particle and also allow the establishment of hydrogen bonds with the conductive polymer, especially PEDOT. These properties therefore make it possible to improve the conductivity.

Preferably, this second nonionic surfactant represents 1% to 20% by mass relative to the dry mass of the shell and of the core.

The particles used according to the invention may alternatively comprise a second ionic surfactant, in particular a second cationic surfactant so as not to create charge incompatibility between the conductive polymer and the second ionic surfactant. For example, the cationic surfactant can be chosen from surfactants of the family of alkyltrimethylammoniums, in particular C4 to C20 alkyltrimethylammoniums. It may be in particular dodecyltrimethylammonium bromide (DTAB).

Preferably, this second ionic surfactant represents 1% to 20% by mass relative to the dry mass of the of the shell and of the core.

In the case where the particles comprise a first nonionic surfactant and a second nonionic or ionic surfactant, the mass ratio between the first nonionic surfactant and the second nonionic or ionic surfactant is preferably between 50/50 and 30/70, end-points included.

The present invention also relates to a method for preparing a dispersion of particles comprising:
a core consisting of a homopolymer of poly-C1-C6-alkyl-acrylate or of a copolymer of C1-C6 alkyl acrylate and an α,β-unsaturated amide comonomer;
a shell comprising a conductive polymer chosen from the group consisting of poly(3,4-ethylenedioxythiophene) (PEDOT), derivatives of PEDOT and poly(3-hexylthiophene) (P3HT);
a nonionic surfactant, said method comprising the steps of:

a) polymerization of C1-C6 alkyl acrylate monomers, and optionally α,β-unsaturated amide monomers, in the presence of a nonionic surfactant and a polymerization catalyst in a dispersing medium to obtain a latex in aqueous solution;

b) dissolving a polyelectrolyte stabilizing the conductive polymer, in particular poly(3,4-ethylenedioxythiophene) (PEDOT), in an aqueous solution to obtain an aqueous solution comprising said polyelectrolyte;

c) adding 3,4-ethylenedioxythiophene (EDOT) monomers, EDOT derivatives or 3-hexylthiophene to the aqueous solution comprising the polyelectrolyte obtained in step (b);

d) adding a polymerization initiator and the latex obtained in step (a) to the solution comprising the polyelectrolyte and the monomers obtained in step (c); and

e) polymerization of the monomers to form the dispersion of particles.

Step (a) of polymerization of the alkyl acrylate monomers can be carried out by any suitable technique accessible to those skilled in the art. In particular, this step can be carried out by the method described in the WO2007012736 application.

Step (b) of dissolving the electrolyte in aqueous solution can be carried out by any suitable technique accessible to those skilled in the art. The concentration of the polyelectrolyte in the aqueous solution can be adapted by those skilled in the art depending on the nature of the polyelectrolyte and the quantity subsequently added EDOT monomers, EDOT derivatives or 3-hexylthiophene. For example, the concentration of the polyelectrolyte can be such that the molar ratio repeating units of the polyelectrolyte:monomers of EDOT, of EDOT derivatives or 3-hexylthiophene is between 1:2 and 2:1, preferably approximately equal to 1:1.

Preferably, the polyelectrolyte stabilizing the conductive polymer, when the latter is poly(3,4-ethylenedioxythiophene) (PEDOT), in an aqueous solution is poly(sodium styrene sulfonate) (PSS).

In one embodiment, the aqueous solution in which the polyelectrolyte is dissolved in step (b) comprises water and sulfuric acid. Unexpectedly, the presence of sulfuric acid in this process simultaneously makes it possible to render compatible the monomers, in particular the EDOT monomers, in water and to increase the conductivity of the polymer obtained (dopant). Indeed, sulfuric acid has a solubility parameter close to that of EDOT which probably favors the compatibilization of EDOT monomers or EDOT derivatives in water. The sulfuric acid:EDOT mass ratio in water is preferably between 2:1 and 1:2, in particular it is about 1:1.

Preferably, the aqueous solution comprising the polyelectrolyte obtained in step (b) does not comprise either ethanol, methanol or chloroform. Preferably, the aqueous solution comprising the polyelectrolyte obtained in step (b) comprises water as sole solvent, or optionally a mixture of water and dimethylsulfoxide (DMSO).

Step (c) of adding the monomers can be carried out by simply adding the monomers to the solution. Alternatively, the monomers can be added in a solvent, for example water, DMSO or a mixture of water and DMSO. The addition can be made with stirring.

Step (d) of adding a polymerization initiator and the latex can be carried out by simultaneously adding the initiator and the latex. Alternatively, the polymerization initiator can be added first, then the latex. The initiator can be chosen from conventional polymerization initiators known to those skilled in the art. These may include ammonium persulfate (APS). The addition can be made with stirring.

Step (e) of polymerization of the monomers can be carried out under conventional conditions known to those skilled in the art for polymerizing said monomers.

In one embodiment, the polymerization of the monomers, in particular the EDOT monomers, in step (e) is carried out in the presence of a co-solvent. Preferably, the co-solvent is dimethyl sulfoxide (DMSO). Unexpectedly, unlike the other co-solvents tested, DMSO does not destabilize the suspension. DMSO can in particular be added during step (c), the addition of the monomers taking place in the form of the addition of a solution of monomers in a solvent comprising DMSO. DMSO is both miscible with water and able to solubilize monomers, in particular EDOT monomers.

Preferably, the polymerization of the monomers in step (e) is carried out in an aqueous medium comprising, as sole solvent, water or a mixture of water and dimethyl sulfoxide. In particular, the aqueous medium in which step (e) is carried out does not include methanol, ethanol or chloroform.

In one embodiment, the method according to the invention further comprises, after step (e), a step (f) of adding a dopant. Any dopant suitable for increasing the conductivity of the conductive polymer or of the mixture of the conductive polymer with the polyelectrolyte stabilizing it, such as the PEDOT:PSS mixture, can be used. For example, the dopant can be selected from the group consisting of sulfuric acid and para-toluenesulfonic acid (PTSA).

Since the process according to the invention is implemented in a dispersed aqueous medium, it is not useful to crosslink the core of the particles before carrying out step (e) of polymerization of the monomers on their surface. Indeed, in the case where the shell would be synthesized in the presence of an organic co-solvent, it would be necessary to crosslink the core of the particles so that it is not dissolved in the solvent. On the contrary, in the process according to the present invention, the crosslinking is not necessary. The absence of crosslinking of the core of the particles makes it possible to maintain the mobility of the polymer chains and the possibility of percolation of the two phases into each other, which contributes to a better stretchability and to a better conductivity of the particles.

The present invention also relates to the use of electrically conductive nanocomposite particles according to the invention or that are obtained by a process according to the invention for producing a print on a stretchable support.

The particles can be used in the form of a dispersion, in particular a dispersion in an aqueous medium, in particular in water. The solids content of the particle dispersion is generally between 1 and 60% by weight of the dispersion, preferably from 10 to 40% by weight.

The term “stretchable support” denotes a material that can withstand an elongation of at least 120% in at least one direction without breaking, and on which the nanocomposite particles according to the invention, or a film formed of such particles, can be printed. Preferably, the stretchable material can withstand an elongation in at least one direction of at least 150%, at least 200%, at least 250%, at least 300% or at least 500%. In some embodiments, the stretchable support may include a greater degree of stretchability in a first direction than in a second direction of the same plane.

As examples of stretchable supports which can be used according to the invention, mention may be made of thermoplastic polymers, such as polypropylene, polyurethane, poly(ethylene terephthalate) or polyethylene. Elastomeric fibers and fabrics comprising such fibers can also be cited. Elastomeric fibers are known to be able to be stretched by at least 400% and then be able to recover their original shape. As examples of elastomeric fibers, mention may be made of elastane fibers (for example Lycra), fibers of natural or synthetic rubber, of olefins, of polyesters, of polyethers or their combinations, in particular elastic threads comprising elastane and polyester. Stretchable supports comprising at least one of the examples of supports mentioned above, even if they are not made of them, can also be used according to the invention.

In one embodiment, the printed stretch support is selected from the group consisting of polypropylene, polyurethane, poly(ethylene terephthalate), polyethylene, elastane fibers, natural or synthetic rubber fibers, olefins, polyesters, polyethers or combinations thereof.

By “producing an impression” with a nanocomposite on a support, is meant depositing the nanocomposite on the substrate, for example by depositing a film of the nanocomposite or by impregnating the fibers of the substrate with the nanocomposite particles, or with a dispersion nanocomposite particles in a solvent, preferably with the nanocomposite particles in their synthesis medium. The deposition can be carried out by all suitable techniques known to those skilled in the art. For the deposition of a film, mention may in particular be made of the deposition of drops (drop casting), screen printing or deposition with equipment of the “Doctor Blade” type.

In one embodiment, the printing is carried out by depositing the nanocomposite particles on the support in the form of a film, or by impregnating all or part of the fibers of the support with a solution or suspension comprising the nanocomposite particles and at least a solvent.

The Applicant has demonstrated that, unexpectedly, the use of the particles described above or of a dispersion containing them to produce a print on a stretchable support makes it possible to obtain a print that is both stretchable and conductive, that is that is to say that its conduction properties are retained even when the stretchable support is stretched, in particular up to an elongation of 200%. In addition, the conduction properties are also maintained when returning the stretchable support to the unstretched state, as well as after several cycles of elongation/return to the unstretched state.

The present invention finally relates to a printed stretchable support, in which the print comprises at least one particle according to the invention or that is obtained by a process according to the invention.

The stretchable support printed according to the invention can obviously take up each of the characteristics and preferred embodiments described in the section relating to the use of nanocomposite particles to produce a print on a stretchable support.

The stretchable support printed according to the invention can be used as such as a stretchable conductive material. It can also in some cases be used to form stretchable electrodes.

The printed conductive substrate according to the invention can be used in a wide variety of fields such as wearable technologies (clothing or accessories comprising advanced computer and electronic elements, designated by the term “wearables” in English), printed electronics, but also coatings for housing or landscaping. For example, devices such as presence detectors and step sensors could be obtained according to the invention.

A printed stretchable support according to the invention, in particular when it is Lycra, has a sensitivity to movement or pressure which is markedly greater, in particular at least times greater, than that which is observed with a similar support, printed with a composite comprising core/shell particles having the same core as those of the present invention and a polyaniline shell as described in the WO2007012736 application. A printed stretch support according to the invention is therefore particularly suitable for forming devices such as presence detectors or step sensors.

A last object of the invention is a detection device sensitive to movement or pressure, in particular a presence detector, movement sensor or step sensor device comprising a printed stretchable support according to the invention.

In the present invention, unless otherwise specified, the term “approximately” of a value v1 designates a value within an interval between 0.9×v1 and 1.1×v1, that is to say v1±10%, of preferably v1±5%, in particular v1±1%.

In the present invention, unless specified otherwise, the intervals of values designate the open intervals not including their end-points. Thus, the terms “greater than” and “less than” refer to strict inequalities.

In the present invention, unless otherwise specified, the verb “comprise” and its variations must be understood as not excluding the presence of other components or steps. In particular embodiments, these terms may be interpreted as “consisting essentially of” or “consisting of”.

Of course, the different characteristics, variants and embodiments of the invention can be associated with each other in various combinations insofar as they are not incompatible or exclusive of each other.

Of course, various other modifications may be made to the invention within the scope of the appended claims.

The examples provided below are intended to illustrate the invention without limiting its scope.

### EXAMPLES

### Example 1: Synthesis of Nanoparticles According to the Invention

1.1 Synthesis of the Core

At first, the surfactants were introduced into water and stirred until complete solubilization. After solubilization, the acryl butylate monomer was added with stirring and the reaction system was heated using an oil bath or a jacket at 70° C. When the emulsion was stabilized, the ammonium persulfate initiator was added. The reaction time was 4 hours.

The synthesis was carried out in water. Table 1 below summarizes the different conditions used in terms of nature of surfactants (TA=surfactant), amount of surfactants (TA m %=mass percentage of surfactant and TA1/TA2=mass ratio of the 2 surfactants used), solid content, as well as the diameter of the particles (latex) obtained. These particles represent the core of the composite electrically conductive particles according to the invention.

TABLE 1

| | | | TA | TA1/ | Solids | Diameter |
|---|---|---|---|---|---|---|
| Assay | TA1 | TA2 | m % | TA2 | percentage | (nm) |
| 1 | Ninol L5 | NP40 | 4 | 35/65 | 30 mol % | 260 |
| 2 | Ninol L5 | BrijS100 | 4 | 35/65 | 30 mol % | 190 |
| 3 | Ninol L5 | BrijS100 | 6 | 35/65 | 30 mol % | 180 |
| 4 | DTAB | BrijS100 | 8 | 50/50 | 10 mol % | 120 |

The particles of assay 1 of table 1 were obtained according to the conditions of the WO2007012736 application.

1.2 Shell Synthesis with Post-Doping

This synthesis was carried out from a latex of particles (core) with a diameter of 260 nm, stabilized with NP40 and Ninol L5 according to assay 1 of table 1 above.

PSS was dissolved in water, then EDOT monomer was added with stirring to the suspension obtained. The molar ratio of EDOT:repeating units of PSS is 1:1. Finally, the polyalkylbutylate latex obtained according to assay 1 of table 1 above was added, as well as the ammonium persulfate initiator. The mass ratio of polyalkylbutylate latex:EDOT is 70:30. A stable dispersion with a conductivity of less than 0.001 S/cm is obtained.

Post-doping of the particles obtained is carried out by adding 10% by mass of sulfuric acid or paratoluene sulphonic acid. The conductivities obtained are 8 S/cm for sulfuric acid, and 2 S/cm for paratoluene sulfonic acid.

1.3 Synthesis of the Bark in the Presence of Sulfuric Acid

The PSS is first dissolved in a water/sulfuric acid mixture, then the EDOT is added to this solution. After stabilization, the polyalkylbutylate latex with a diameter of 120 nm, stabilized with DTAB and BrijS100 according to test 4 of table 1, is added with stirring. Finally, the ammonium persulfate (APS) initiator is introduced into the reaction system and the polymerization is continued at room temperature for 3 days. The EDOT:PSS:sulfuric acid molar ratio used is 1:1:1. The synthesis was performed for four different latex polyalkylbutylate:EDOT ratios, 70:30, 75:25, 80:20 and 85:15. The conductivities are respectively 9 S/cm, 20 S/cm, 3 S/cm and 0.5 S/cm.

1.4 Synthesis of the Shell in the Presence of a DMSO Co-Solvent

This synthesis is carried out as described above in paragraph 1.3, with, in addition, solubilization of the EDOT monomers in DMSO before their addition to the latex of polyalkylbutylate with a diameter of 120 nm, stabilized with DTAB and BrijS100 according to test 4 of Table 1. DMSO is added in an amount equal to 5% of the total water. The molar ratio of polyalkylbutylate latex:EDOT is 75:25. The conductivity obtained for this test is 12 S/cm.

### Example 2: Measurement of the Resistance to Stretching of Composite Films and Substrates on which the Composites are Deposited

2.1 Deposition on a Thermoplastic Polyurethane Substrate

A first series of tests was carried out on thermoplastic polyurethane (TPU) in order to evaluate the variation of the resistance according to stretching. A particle composite film according to the invention with a PBuA:PEDOT ratio of 75:25, a core diameter of approximately 120 nm, stabilized by DTAB and BrijS100 according to assay 4 of table 1, and a conductivity of 20 S/cm was deposited on a polyurethane substrate by drop casting. In order to measure resistance under stretching, the specimen is placed between two jaws of a Versatest brand motorized bench. The lower jaw is fixed and the upper jaw is movable. The electrical contact is ensured by gold needles which are in contact with the film inside the jaws while the resistance measurement is carried out by a keithley. The traction arm and the keithley are connected to an acquisition software which allows the control of the stretch. Thus, tensile cycles can be performed while measuring resistance.

Stretch Test Protocol

This test consists in determining the value of the resistance under stretching. Two phases of stretching are studied, the first during stretching (50 mm/min), a period during which the traction arm is in motion, and the second once the specimen has been stretched. The resistance of a sample is proportional to the ratio between the length (distance between the electrodes) of the specimen and its section (product of the width and the thickness). When stretching, the length increases and the section decreases, which leads to an increase in the resistance value. Then, once stretched, relaxation takes place, leading to a decrease in resistance value.

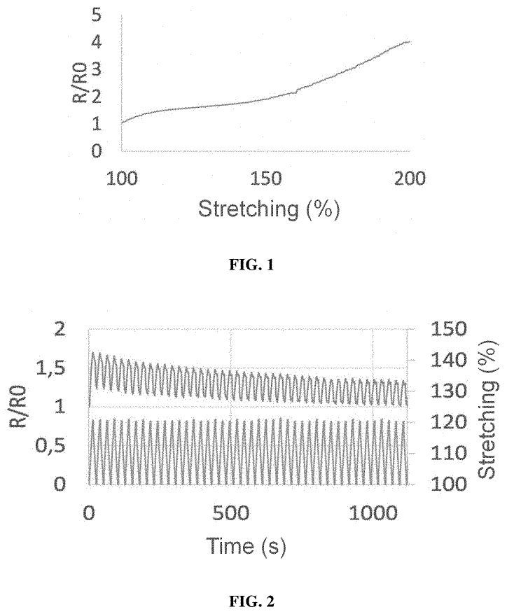

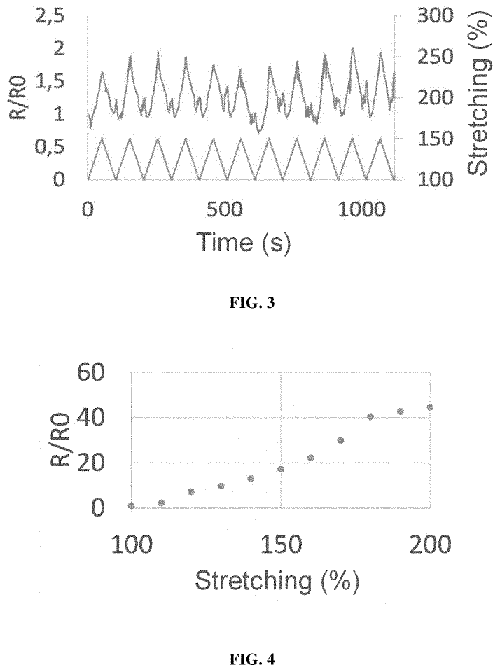

A first 200% stretching of the TPU substrate on which the composite film is deposited led to an increase in the value of the resistance by a factor of 4. FIG. 1 shows the evolution of the resistance of the substrate on which is deposited the composite according to the stretch. Stretching cycles were then performed with stretches of 120 and 150%. The graphs presenting the evolution of resistance and stretching over time for these two tests are presented respectively in FIG. 2 and FIG. 3. An increase in resistance is observed during stretching, and a decrease in resistance is observed during relaxation. Regardless of the stretching applied to the test piece, the electrical continuity is preserved, and the value of the resistance returns to its initial value when the substrate is relaxed.

The fact that resistance can be measured during stretch/relaxation cycles confirms that the material retains its conductivity when stretched. Indeed, should it not have been the case, the electrical continuum would be broken and we would no longer be able to measure resistance. Consequently, the composite film deposited on the substrate is stretchable and does not undergo degradation, and its conductivity is preserved even after several stretching/relaxing cycles.

2.2 Deposition on a Lycra Substrate

A composite of particles according to the invention with a PBuA:PEDOT ratio of 75:25, a core diameter of approximately 120 nm, stabilized by DTAB and BrijS100 according to assay 4 of table 1, and a conductivity of 20 S/cm was deposited on a stretched Lycra substrate, which allows good impregnation of the fibers. The value of the resistance varies very rapidly when the material undergoes movement. Nevertheless, it is possible to measure the resistance after stabilization. As shown in FIG. 4, resistance value increases with stretch. The high sensitivity to movement of this composite/Lycra couple makes it a good candidate for all applications benefiting from high sensitivity, such as touch or presence sensors. After relaxation of the stretch, the resistance returned to its initial value.

2.3 Deposition on an Elastic Thread

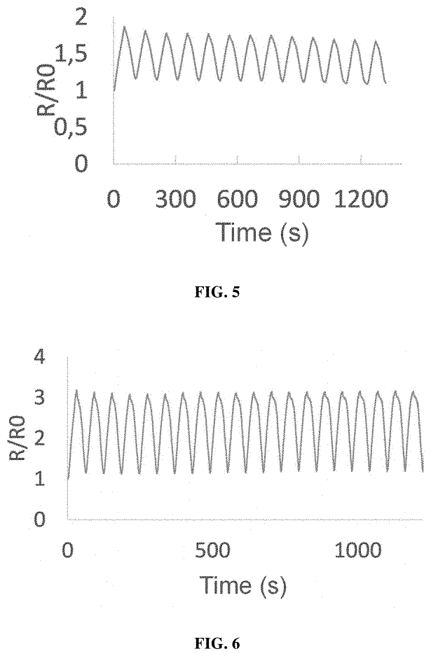

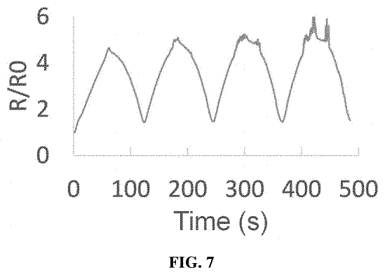

The aforementioned conductive composite was coated on an elastic yarn composed of 60% spandex and 40% polyester. To do this, and in order to wet all the air-wire interface possible, the wire is first stretched to its maximum, then covered by the conductive composite and kept stretched for the drying time. Once dry, tests similar to those carried out on thermoplastic polyurethane film or on textiles were carried out, namely the monitoring of the resistance according to the stretch. The behavior observed is identical to that observed previously, the resistance increases during stretching and decreases during relaxation. Thus, cycles were performed at different stretch rates. FIGS. 5 to 7 show that the specimen is neither damaged nor degraded by the cycles of stretching undergone, and that the conductivity is preserved during stretching and relaxation. The results were obtained for stretches of 110% (FIG. 5), 125% (FIG. 6), and 150% (FIG. 7).

1.-10. (canceled)

11. An electrically conductive nanocomposite particles comprising:
a core consisting of a homopolymer of poly-C1-C6-alkyl-acrylate or of a copolymer of C1-C6 alkyl acrylate and an α,β-unsaturated amide comonomer;
a shell comprising a conductive polymer selected from the group consisting of poly(3,4-ethylenedioxythiophene) (PEDOT), derivatives of PEDOT and poly(3-hexylthiophene) (P3HT); and
a nonionic surfactant.

12. The electrically conductive nanocomposite particles according to claim 11, wherein the poly-C1-C6-alkyl-acrylate is poly n-butyl acrylate.

13. The electrically conductive nanocomposite particles according to claim 11, wherein the poly-C1-C6 alkyl-acrylate homopolymer or the copolymer of C1-C6 alkyl acrylate and an α,β-unsaturated amide comonomer is not cross-linked.

14. The electrically conductive nanocomposite particles according to claim 11, wherein the core diameter of the particles, measured by dynamic light scattering, is less than 200 nm.

15. A method for preparing a dispersion of electrically conductive nanocomposite particles comprising:
a core consisting of a homopolymer of poly-C1-C6-alkyl-acrylate or of a copolymer of C1-C6 alkyl acrylate and an α,β-unsaturated amide comonomer;
a shell comprising a conductive polymer selected from the group consisting of poly(3,4-ethylenedioxythiophene) (PEDOT), derivatives of PEDOT and poly(3-hexylthiophene) (P3HT); and
a nonionic surfactant,
said process comprising the steps of:
(a) polymerization of C1-C6 alkyl acrylate monomers, and optionally α,β-unsaturated amide monomers, in the presence of a nonionic surfactant and a polymerization catalyst in a dispersing medium to obtain a latex in aqueous solution;
(b) dissolving a polyelectrolyte stabilizing the conductive polymer in an aqueous solution to obtain an aqueous solution comprising said polyelectrolyte;
(c) adding 3,4-ethylenedioxythiophene (EDOT) monomers, EDOT derivatives or 3-hexylthiophene to the aqueous solution comprising the polyelectrolyte obtained in step (b);
(d) adding a polymerization initiator and the latex obtained in step (a) to the solution comprising the polyelectrolyte and the monomers obtained in step (c); and
(e) polymerization of the monomers to form the dispersion of electrically conductive nanocomposite particles.

16. The method for preparing a dispersion of electrically conductive nanocomposite particles according to claim 15, wherein the aqueous solution in which the polyelectrolyte is dissolved in step (b) comprises water and sulfuric acid.

17. The method for preparing a dispersion of electrically conductive nanocomposite particles according to claim 15, wherein the process further comprises, after step (e), a step (f) of adding a dopant.

18. The method for preparing a dispersion of electrically conductive nanocomposite particles according to claim 17, wherein the dopant is selected from the group consisting of sulfuric acid and para-toluenesulfonic acid (PTSA).

19. A method of printing on a stretchable support, comprising the steps of providing electrically conductive nanocomposite particles comprising:
a core consisting of a homopolymer of poly-C1-C6-alkyl-acrylate or of a copolymer of C1-C6 alkyl acrylate and an α,β-unsaturated amide comonomer;
a shell comprising a conductive polymer selected from the group consisting of poly(3,4-ethylenedioxythiophene) (PEDOT), derivatives of PEDOT and poly(3-hexylthiophene) (P3HT);
a nonionic surfactant; and
printing the electrically conductive nanocomposite particles on the stretchable support.

20. The method of printing on a stretchable support according to claim 19, wherein the electrically conductive nanocomposite particles are obtained by a process comprising the steps of:
(a) polymerization of C1-C6 alkyl acrylate monomers, and optionally α,β-unsaturated amide monomers, in the presence of a nonionic surfactant and a polymerization catalyst in a dispersing medium to obtain a latex in aqueous solution;
(b) dissolving a polyelectrolyte stabilizing the conductive polymer in an aqueous solution to obtain an aqueous solution comprising said polyelectrolyte;
(c) adding 3,4-ethylenedioxythiophene (EDOT) monomers, EDOT derivatives or 3-hexylthiophene to the aqueous solution comprising the polyelectrolyte obtained in step (b);
(d) adding a polymerization initiator and the latex obtained in step (a) to the solution comprising the polyelectrolyte and the monomers obtained in step (c); and
(e) polymerization of the monomers to form the dispersion of electrically conductive nanocomposite particles.

21. A printed stretchable support, wherein the print comprises at least one electrically conductive nanocomposite particle comprising:
a core consisting of a homopolymer of poly-C1-C6-alkyl-acrylate or of a copolymer of C1-C6 alkyl acrylate and an α,β-unsaturated amide comonomer;
a shell comprising a conductive polymer selected from the group consisting of poly(3,4-ethylenedioxythiophene) (PEDOT), derivatives of PEDOT and poly(3-hexylthiophene) (P3HT); and
a nonionic surfactant.

22. The printed stretchable support according to claim 21, wherein the at least one electrically conductive nanocomposite particle is obtained by a process comprising the steps of:
(a) polymerization of C1-C6 alkyl acrylate monomers, and optionally α,β-unsaturated amide monomers, in the presence of a nonionic surfactant and a polymerization catalyst in a dispersing medium to obtain a latex in aqueous solution;
(b) dissolving a polyelectrolyte stabilizing the conductive polymer in an aqueous solution to obtain an aqueous solution comprising said polyelectrolyte;
(c) adding 3,4-ethylenedioxythiophene (EDOT) monomers, EDOT derivatives or 3-hexylthiophene to the aqueous solution comprising the polyelectrolyte obtained in step (b);
(d) adding a polymerization initiator and the latex obtained in step (a) to the solution comprising the polyelectrolyte and the monomers obtained in step (c); and
(e) polymerization of the monomers to form the dispersion of electrically conductive nanocomposite particles.
